(19) United States
(12) Patent Application Publication
(10) Pub. No.: US 2008/0126489 A1
(43) Pub. Date: May 29, 2008

(54) METHOD AND APPARATUS TO MANAGE E-MAIL MESSAGES

(76) Inventors: Prasad Venkata Potluri, Austin, TX (US); Ched David Hays, Austin, TX (US); Suhail Hasan Kazi, Austin, TX (US); Sharmila Potluri, Austin, TX (US); Suzanne Shi, Austin, TX (US)

Correspondence Address: IBM CORP (YA);C/O YEE & ASSOCIATES PC, P.O. BOX 802333, DALLAS, TX, 75380, US

(21) Appl. No.: 11/563,851

(22) Filed: Nov. 28, 2006

(51) Int. Cl. G06F 15/16

(52) U.S. Cl. 709/206

(57) ABSTRACT

A computer implemented method, apparatus, and computer usable program product for managing e-mail messages. Responsive to receiving an e-mail message for a recipient, a determination is made as to whether a condition is present in the e-mail message using a policy associated with the recipient. If the condition is present in the e-mail message, a determination is made as to whether a number of other e-mail messages having the condition exceed a threshold associated with condition. An oldest e-mail message is removed from the number of e-mail messages having the condition in response to a determination that the number of e-mail messages exceeds the threshold.

### BACKGROUND OF THE INVENTION

1. Field of the Invention

The present invention relates generally to an improved data processing system and in particular to a method and apparatus for processing e-mail messages. Still more particularly, the present invention relates to a computer implemented method, apparatus, and computer usable program code for managing stored e-mail messages.

2. Description of the Related Art

The Internet is a global network of computers and networks joined together by gateways that handle data transfer and the conversion of messages from a protocol of a sending network to a protocol used by a receiving network. On the Internet, any computer may communicate with any other computer. Information between computers travels over the Internet through a variety of languages, also referred to as protocols. The set of protocols used on the Internet is called the Transmission Control Protocol/Internet Protocol (TCP/IP).

The Internet has revolutionized communications and commerce as well as being a source of information and entertainment. For many users, e-mail is a widely used format to communicate over the Internet. It is commonplace for users to send e-mail messages to other users through the Internet.

The use of e-mail messages is commonplace for personal and business use. E-mail messages are used by individuals to keep in touch with and communicate with other users. Additionally, e-mail messages provide a medium to collaborate and exchange documents.

A user may subscribe to receive periodic e-mail messages for different events. These events may include, for example, stock market reports, patch releases, and daily special deals bulletins. Sometimes it is difficult for a user to review all of the different e-mail messages received and delete unnecessary e-mails because of other higher priority messages or tasks that have to be done. Further, when a user's e-mail messages are stored remotely on a server, storage limits are often present. As a result, a user is unable to receive additional new e-mail messages if storage space limits are exceeded for the user's account.

In many cases the user will delete the oldest e-mail messages from the different types of messages received. For example, a user may keep the latest five messages regarding stock market reports and the latest twenty messages about patches, while keeping only the latest message about daily special deals. Having to manually delete these messages on some periodic basis is necessary to prevent an inbox from becoming too full. Even with using rules to automatically place messages in different folders, a user still has to go through those messages and delete ones that the user no longer wishes to keep.

Therefore, it would be advantageous to have an improved computer implemented method, apparatus, and computer usable program code for managing e-mail messages.

### SUMMARY OF THE INVENTION

The illustrative embodiments provide a computer implemented method, apparatus, and computer usable program product for managing e-mail messages. Responsive to receiving an e-mail message for a recipient, a determination is made as to whether a condition is present in the e-mail message using a policy associated with the recipient. If the condition is present in the e-mail message, a determination is made as to whether a number of other e-mail messages having the condition exceed a threshold associated with condition. An oldest e-mail message is removed from the number of e-mail messages having the condition in response to a determination that the number of e-mail messages exceeds the threshold.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system is shown in which illustrative embodiments may be implemented;

FIG. 3 is a diagram illustrating an e-mail messaging system in accordance with an illustrative embodiment of the present invention;

FIG. 4 is a diagram illustrating components used for handling e-mail messages in accordance with an illustrative embodiment;

FIG. 5 is a diagram illustrating example rules in a policy in accordance with an illustrative embodiment; and

FIG. 6 is a flowchart of a process for managing e-mail messages in accordance with an illustrative embodiment.

### DETAILED DESCRIPTION OF THE PREFERRED EMBODIMENT

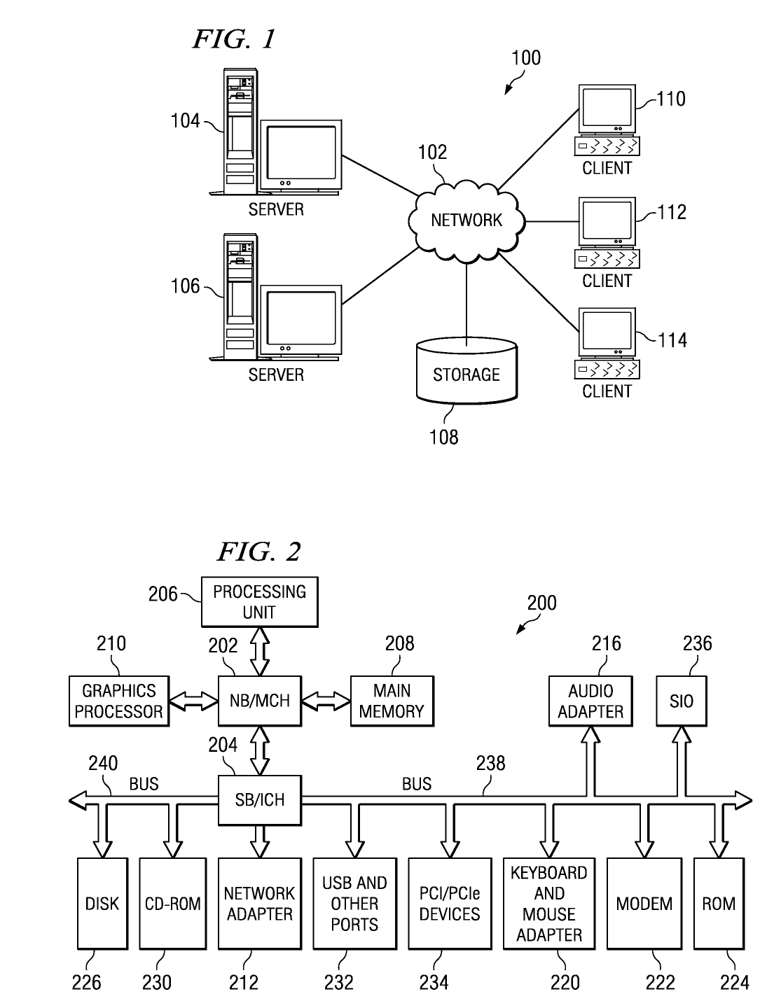

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and/or applications to clients 110, 112, and 114. Clients 110, 112, and 114 are clients to server 104 in this example and use server 106 to exchange e-mail messages. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide a computer implemented method, apparatus, and computer usable program code for managing e-mail messages. Responsive to receiving an e-mail message for recipient, a determination is made as to whether a condition is present in the e-mail message using a policy associated with the recipient. In response to the condition being present in the e-mail message, a determination is made as to whether the number of e-mail messages having this condition exceeds a threshold associated with the condition. In response to a determination that the number of e-mail messages exceeds the threshold, an oldest e-mail message is deleted from the number of e-mail messages having the condition and the new incoming e-mail message will be processed and accepted.

In these examples, the policy is a set of rules. These rules may define a sender and the condition defined by the rule may be, for example, whether an e-mail message is from the particular sender. In this manner, a selected number of e-mail messages from a particular sender may be kept with messages exceeding that number being deleted such that only the most recent messages are kept. The policy may define other conditions, such as a presence of a certain string being in the subject line of an e-mail message. In these illustrative examples, these different processes are located on an e-mail server. Of course, depending on the particular implementation, these processes may be located in a client e-mail program.

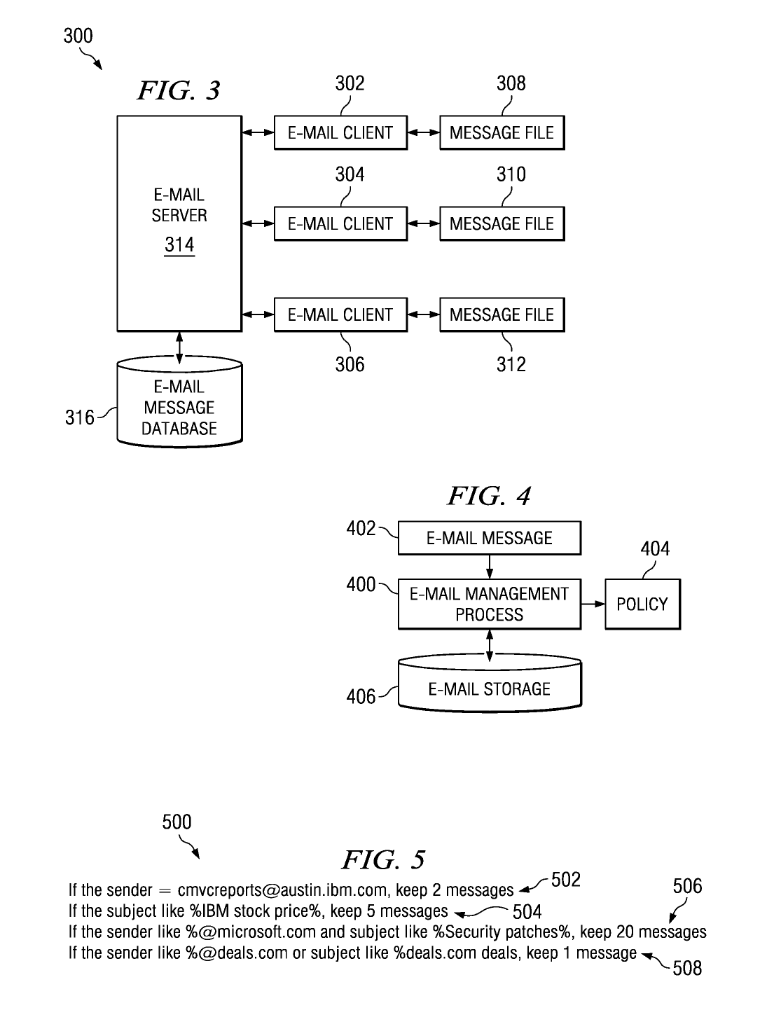

Turning now to FIG. 3, a diagram illustrating an e-mail messaging system is depicted in accordance with an illustrative embodiment of the present invention. In this example, e-mail messaging system 300 contains e-mail client 302, e-mail client 304, and e-mail client 306, which are e-mail clients, programs, or applications located at different client data processing systems, such as client 110, client 112, and client 114 in FIG. 1. Message file 308, message file 310, and message file 312 are associated with these e-mail clients respectively. These message files store e-mail messages received by the clients and may be organized into various mailboxes. Examples of various mailboxes include, for example, an in folder, a sent folder, a deleted folder, and an outbox folder.

These e-mail programs may employ different protocols depending upon the implementation. For example, simple mail transfer protocol (SMTP) is a standard e-mail protocol that is based on TCP/IP. This protocol defines a message format and the message transfer agent which stores and forwards the e-mail. Other protocols, such as post office protocol 3 (POP3), also may be employed.

These e-mail programs are used to send e-mails back and forth to different users through e-mail server 314. Messages sent to other e-mail clients are stored in e-mail message database 316. When an e-mail client connects to e-mail server 314, any messages for that particular client are then sent to the client.

E-mail clients 302, 304, and 306 can be presently available e-mail clients. For example, these e-mail clients can be Microsoft Outlook or Eudora. Microsoft Outlook is available from Microsoft Corporation, and Eudora is available from Qualcomm, Inc.

In these depicted examples, the different processes used to handle e-mail messages are located in e-mail server 314. In this illustrative embodiment, e-mail server 314 includes an e-mail management process that is used to determine whether a condition is present in the e-mail message using a policy and to determine whether the number of other e-mail messages for the same recipient having this condition and the received e-mail message exceeds some threshold. The threshold is a value that may be user selected or a default value, depending on the implementation. This process is also used to delete an oldest e-mail message from a group of e-mail messages having the condition if the threshold is exceeded.

Turning next to FIG. 4, a diagram illustrating components used for handling e-mail messages is depicted in accordance with an illustrative embodiment. In these examples, e-mail management process 400 is a process that may be located in e-mail server 314 in FIG. 3. When e-mail message 402 is received by e-mail management process 400, e-mail message 402 is examined using policy 404. In these examples, policy 404 is a set of rules that may be specified by a user to control the number of messages stored for that user in e-mail storage 406. E-mail storage 406 is an example of storage within message database 316 in FIG. 3.

A user may set rules or define conditions in policy 404. If e-mail message 402 meets a rule within policy 404, then an action is initiated. This action also may be defined within policy 404 in these different examples. In the depicted embodiments, e-mail message 402 is considered to satisfy a “condition” if e-mail message 402 meets a rule in policy 404.

For example, a rule within policy 404 may state that if e-mail message 402 is from a selected sender, only two e-mail messages from that selected sender are to be kept within e-mail storage 406. Thus, e-mail management process 400 determines whether the number of e-mail messages in e-mail storage 406 from that selected sender exceeds some threshold. These other e-mail messages in e-mail storage 406 also are considered to have the same condition as e-mail message 402. If the threshold is exceeded, the oldest e-mail message from that sender is deleted from e-mail storage 406.

E-mail message 402 is then saved within e-mail storage 406. Of course, e-mail message 402 also may be saved prior to or at the same time that policy 404 is being applied to e-mail message 402 depending on the particular implementation.

With reference now to FIG. 5, a diagram illustrating example rules in a policy is depicted in accordance with an illustrative embodiment. In this example, policy 500 contains rules 502, 504, 506, and 508. Policy 500 is an example of a policy, such as policy 404 in FIG. 4. Rule 502 indicates that if the sender of the e-mail message is equal to “cmvcreports@austin.ibm.com” that only two of those e-mail messages should be kept at any one time within e-mail storage for the recipient. With this rule, if the sender is equal to “cmvcreports@austin.ibm.com”, a true value is returned. If the sender field is equal to “austincmvcreports@austin.ibm.com”, a false value is returned. Basically, this rule requires an exact string match.

Rule 504 indicates that if any of the e-mail messages includes “IBM stock price” in the subject only up to five e-mail messages meeting that condition are to be kept within the e-mail storage.

Rule 506 indicates that if the sender string ends with “@microsoft.com” and the subject contains the string “Security patches”, only up to twenty e-mail messages having this condition are to be kept in the e-mail storage. If the e-mail message has a condition in which the senders e-mail address string ends with “@deals.com” or the subject string ends with “deals.com deals”, that only one such message should be kept having this condition as shown in rule 508. When these conditions are met, an oldest e-mail message having that condition is removed, if the number of e-mail messages having the condition exceeds the identified threshold for the particular rule.

As another example, if the rule is ‘sender like “%@microsoft.com”’, then a true value is returned if the sender is equal to “windows@microsoft.com”. A false value is returned if the field is equal to “abc@microsoft.com.au”. Basically, the percent (%) symbol means that zero or more characters are to be present. In yet another example, if the rule is ‘sender like “%microsoft%”’, then a true value is returned if the sender field is equal to “microsoftid@hotmail.com”. A true result also is returned if the sender field is equal to “us_microsoft@gmail.com”. Another true result occurs if the sender field is equal to “abc@microsoft.com”. A false result is returned in this example if the sender field is equal to “my_micro_soft@msn.com”. In this example, “microsoft” is not found as a string within the sender field. A similar syntax may be applied to the subject fields or other fields depending on the particular implementation.

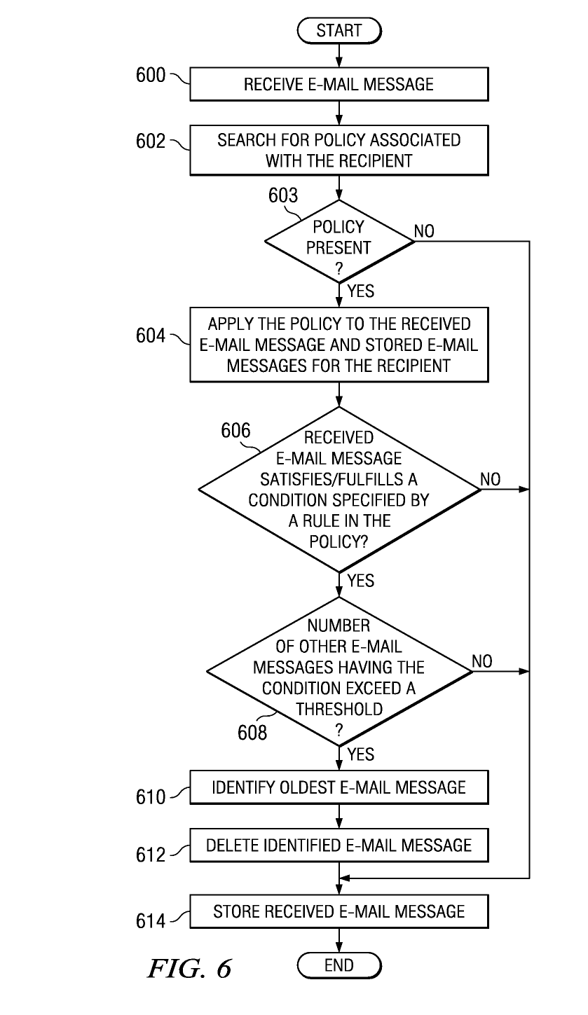

Turning now to FIG. 6, a flowchart of a process for managing e-mail messages is depicted in accordance with an illustrative embodiment. The process illustrated in FIG. 6 may be implemented in a process, such as e-mail management process 400 in FIG. 4.

The process begins by receiving an e-mail message (step 600). Thereafter, the process searches for a policy associated with the recipient (step 602). A determination is made as to whether a policy associated with the recipient has been found (step 603). If a policy is found in step 603, the policy is then applied with respect to the e-mail message and to other stored e-mail messages for the recipient (step 604).

Next, a determination is made as to whether the received e-mail message satisfies a condition specified by a rule in the policy (step 606). If the received e-mail message satisfies the condition specified in the e-mail policy, a determination is made as to whether the number of other e-mail messages having the condition exceeds a threshold (step 608). In this example, the threshold is associated with or located in the rule in the policy. If the number of other e-mail messages having the condition exceeds the threshold, then the oldest e-mail message is identified (step 610). The identified e-mail message is deleted (step 612). Alternatively, the e-mail message may be handled differently other than just deleting the e-mail message. For example, the e-mail message may be placed in an archive file locally or in a remote location. Then, the received e-mail message is stored (step 614), with the process terminating thereafter.

With reference again to step 608, if the number of other e-mail messages having the condition do not exceed the threshold, the process proceeds to step 614 as described above. In this case, the maximum number of e-mail messages desired for a particular condition have not been exceeded. Thus, e-mail messages do not need to be deleted or removed.

With reference again to step 606, if the received e-mail message does not fulfill a condition specified by a rule in a policy, then the process proceeds to step 614 to store the e-mail message without deleting any other e-mail messages. With reference again to step 603, if a policy is not found, the process proceeds directly to step 614.

Thus, the illustrative embodiments provide a computer implemented method, apparatus, and computer usable program product for managing e-mail messages. When an e-mail message is received from a recipient, a determination is made as to whether a condition is present in the e-mail message using a policy associated with the recipient. If the condition is present in the e-mail message, a determination is then made as to whether the number of e-mail messages having the condition exceeds a threshold associated with the condition. If the number of e-mail messages exceeds the threshold, an oldest e-mail message from the number of e-mail messages is deleted or archived locally or in a remote storage location.

In this manner, a user is able to control the number of e-mail messages retained having a particular condition. As described above, these conditions may be specified by the user. The condition may be that the e-mail message is from a particular sender or that the e-mail message has a particular string within the subject line. Further, the condition may be a combination of the e-mail message being from a particular sender and having a particular string or the e-mail message being from a particular sender or having the particular string.

Of course, other types of rules or conditions may be specified by the user. For example, the e-mail message may be required to have a particular string located in the body of the e-mail message. The different rules that may be used depend on the particular implementation and user in these examples. Further, although the depicted examples illustrate the processes as being implemented in an e-mail server, these processes also may be implemented within an e-mail client with respect to e-mail messages stored locally in a message store for that client. For example, this policy could be applied to an e-mail client, such as e-mail client 302 and message file 308 as described in FIG. 3.

Although the depicted examples illustrate deleting an e-mail message, other embodiments may handle the e-mail message that is to be removed in other fashions. For example, the oldest e-mail message may be placed in an archive file locally at the client or on some other storage facility. In addition, an option may be configured to determine whether an oldest email message is to be deleted or archived when that email message is removed. For example, if a configurable option save_old_message is set to “true”, and another configurable parameter old_messages_path is set to a directory path, the oldest message will be saved in the old_messages_path directory and deletes from the e-mail files. If the configurable option save_old_message is set to “false”, the oldest e-mail message will be deleted from the e-mail files.

This type of feature is especially useful if the user desires to keep the e-mail messages, but is required to remove e-mail messages because of space storage limitations. Further, instead of removing only a single e-mail message, the process may remove two or more e-mail messages when the threshold is exceeded.

In another embodiment, the number of email messages may be kept equal to zero, rather than keeping a particular number of email messages. If the number of email messages is set equal to zero, then the incoming email message is not saved. Instead, this email message may be deleted or save in an archive and deleted depending on the particular implementation.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing e-mail messages, the computer implemented method comprising:
responsive to receiving an e-mail message for a recipient, determining whether a condition is present in the e-mail message using a policy associated with the recipient;
responsive to the condition being present in the e-mail message, determining whether a number of other e-mail messages having the condition exceeds a threshold associated with condition; and
responsive to a determination that the number of e-mail messages exceeds the threshold, removing an oldest e-mail message from the number of e-mail messages having the condition.

2. The computer implemented method of claim 1, wherein the policy defines a sender and wherein the step of determining whether a condition is present in the e-mail message using a policy comprises:
determining whether e-mail message is from the sender.

3. The computer implemented method of claim 1, wherein the policy defines a sender and wherein the step of determining whether a condition is present in the e-mail message using a policy comprises:
determining whether e-mail message contains a selected string in field identifying the sender of the e-mail message.

4. The computer implemented method of claim 1, wherein the policy defines a string for a subject line in the e-mail message and wherein the step of determining whether a condition is present in the e-mail message using a policy comprises:
determining whether the string is present in the subject line of the e-mail message.

5. The computer implemented method of claim 1, wherein the computer implemented method is located in an e-mail server.

6. The computer implemented method of claim 1, wherein the computer implemented method is located in a client e-mail program.

7. The computer implemented method of claim 1 further comprising:
responsive to removing the oldest e-mail message, determining whether to archive the oldest email message; and
responsive to a determination to archive the oldest e-mail message, placing the oldest e-mail message in an archive file in a local location or a remote location.

8. A computer program product comprising:
a computer usable medium having computer usable program code for managing e-mail messages, the computer program medium comprising:
computer usable program code, responsive to receiving an e-mail message for a recipient, for determining whether a condition is present in the e-mail message using a policy associated with the recipient;
computer usable program code, responsive to the condition being present in the e-mail message, for determining whether a number of other e-mail messages having the condition exceeds a threshold associated with condition; and
computer usable program code, responsive to a determination that the number of e-mail messages exceeds the threshold, for removing an oldest e-mail message from the number of e-mail messages having the condition.

9. The computer program product of claim 8, wherein the policy defines a sender and wherein the computer usable program code, responsive to receiving an e-mail message for a recipient, for determining whether a condition is present in the e-mail message using a policy associated with the recipient comprises:
computer usable program code for determining whether e-mail message is from the sender.

10. The computer program product of claim 8, wherein the policy defines a string for a subject line in the e-mail message and wherein the computer usable program code, responsive to receiving an e-mail message for a recipient, for determining whether a condition is present in the e-mail message using a policy associated with the recipient comprises:
computer usable program code for determining whether the string is present in the subject line of the e-mail message.

11. The computer program product of claim 8, wherein the computer program product is located in an e-mail server.

12. The computer program product of claim 8, wherein the computer program product is located in a client e-mail program.

13. A data processing system comprising:
a bus;
a communications unit connected to the bus;
a storage device connected to the bus, wherein the storage device includes computer usable program code; and
a processor unit connected to the bus, wherein the processor unit executes the computer usable program code to determine whether a condition is present in the e-mail message using a policy associated with the recipient in response to receiving an e-mail message for a recipient; determine whether a number of other e-mail messages having the condition exceeds a threshold associated with condition in response to the condition being present in the e-mail message; and remove an oldest e-mail message from the number of e-mail messages having the condition in response to a determination that the number of e-mail messages exceeds the threshold.

14. The data processing system of claim 13, wherein the policy defines a sender and wherein in executing the computer usable program code to determine whether a condition is present in the e-mail message using a policy, the processor unit executes the computer usable program code to determine whether e-mail message is from the sender.

15. The data processing system of claim 13, wherein the policy defines a string for a subject line in the e-mail message and wherein in executing the computer usable program code to determine whether a condition is present in the e-mail message using a policy, the processor unit executes the computer usable program code to determine whether the string is present in the subject line of the e-mail message.
